(19) United States
(12) Patent Application Publication
(10) Pub. No.: US 2002/0103988 A1
(43) Pub. Date: Aug. 1, 2002

(54) Microprocessor with integrated interfaces to system memory and multiplexed input/output bus

(76) Inventor: Pascal Dornier, Sunnyvale, CA (US)

Correspondence Address: CENTRAL COAST PATENT AGENCY, PO BOX 187, AROMAS, CA, 95004, US

(21) Appl. No.: 10/104,882

(22) Filed: Mar. 22, 2002

Related U.S. Application Data
(63) Continuation of application No. 08/769,582, filed on Dec. 18, 1996, now abandoned.

(51) Int. Cl. G06F 15/76; G06F 15/00

(52) U.S. Cl. 712/38

(57) ABSTRACT

A single-chip IC device has an on-board CPU, an I/O bus controller, and a memory controller all implemented in semiconductor devices on the chip. The CPU, I/O bus controller, and memory controller are interconnected on the IC chip by a parallel data and address bus formed by the IC manufacturing techniques of deposition, patterning, and etching. In a preferred embodiment the on-board local bus has 32 address and 32 data lines. Also in a preferred embodiment the I/O bus controller has 32 data and address paths off the die for connection to a multiplexed I/O bus. The memory controller in the same embodiment has 32 data and 11 address paths off the die to a memory bus with 43 data and address lines. The I/O bus controller is configured to rout memory requests from peripheral devices through the memory controller directly to system memory.

### CROSS-REFERENCE TO RELATED DOCUMENTS

The present invention is continuation patent application of patent application Ser. No. 08/769,582 filed on Dec. 18, 1996, attorney docket number P228FWC2. The disclosure of application Ser. No. 08/769,582 is incorporated herein in its entirety by reference.

### FIELD OF THE INVENTION

The present invention relates generally to desktop computers, specifically to the integration of a central processing unit, system memory controller, and multiplexed input/output bus controller onto a single physical device.

### BACKGROUND OF THE INVENTION

The main circuit board of a typical desktop computer is commonly known as a motherboard. FIG. 1 is a simplified block diagram of IC's and interconnections as conventionally implemented on such a motherboard. Its major components include a central processing unit (CPU) 27 for performing computations and managing computer operations according to stored routines, system memory comprised of dynamic random access memory (DRAM) chips 37 for storage of data, and a multiplexed, or combined address and data, input/output (I/O) bus 39 for the connection of I/O devices, such as disk drive controller boards, video co-processor boards, sound boards, fax/modem boards, etc.

A discrete memory controller 33 regulates the flow of signals between system memory and CPU 27 typically over a local bus 45 comprising separate data paths 29 and address paths 31. When the CPU needs information stored in system memory, it makes an off-chip request to external memory controller 33, which fetches the data stored in the address specified by the CPU. The memory controller is usually tailored to a particular type of bus structure, such as the Industry Standard Architecture (ISA) bus, MicroChannel bus, TurboChannel bus, etc. A memory bus 41 connects the memory controller to system memory.

A discrete, multiplexed I/O bus controller 35 regulates the flow of signals between devices on I/O bus 39, such as device 47, and CPU 27. The CPU can make requests to I/O controller 35 to access an I/O device, or an I/O device can initiate an access. The I/O bus is the connection between the I/O bus controller and the I/O devices. It is comprised primarily of a set of circuit paths terminating at several connectors for the installation of I/O devices. I/O bus controller 35 and memory controller 33 are connected in parallel, so that in addition to the regulation of signals between themselves and the CPU, they also serve as a “bridge” that routes memory access requests from I/O devices to system memory.

In a desktop computer with a 32 bit CPU, such as the Intel 80486DX, 32 address pins and 32 data pins are required on the chip, so that addresses and data can be communicated on separate paths. Therefore, the CPU has a total of 64 address and data pins. On the other hand, typical DRAM chips have 32 data pins, but only 11 address pins. When the CPU tries to access a particular address in memory, the memory controller separates the address into row and column portions, then sequentially communicates the two address components to system memory. The memory controller consequently requires 64 address and data pins for connecting to the CPU, and 43 address and data pins for connecting to system memory. To help reduce pin count, multiplexed I/O bus 39 alternately carries address and data multiplexed on the same 32 pins and paths. I/O controller 35 consequently requires 64 address and data pins for connecting to the CPU, and 32 pins for connecting to the I/O bus and peripheral devices. The number of address and data pins among the discrete CPU, memory controller, and I/O controller add up to a high total of 267. Of course, additional control pins are typically needed as well. Because the size of a chip's package is largely dictated by the number of pins (leads) it carries, the large number of pins required by a conventional computer design require relatively large chip packages.

Connecting these physically separate chips creates interface overhead which significantly reduces system performance. For example, the time delays of input and output pins on typical computer chips are generally 10 ns and 15 ns, respectively. A 5 ns safety margin is normally added. As a result, an address cycle from the CPU will have a total delay of 30 ns, or 1 clock cycle. The delay of a data cycle from system memory will take another 30 ns and clock cycle. Therefore the entire read delay will require 2 clock cycles. Similar delays occur when an I/O device, such a networking board, on the I/O bus issues memory access requests. These clock cycles, or wait states, are detrimental to system performance.

The performance penalty imposed by the slow system memory can be alleviated to some extent by the use of a cache memory 43 comprised of much faster static RAM (SRAM) chips. The SRAM, also controlled by the memory controller, holds the most frequently used information so that it can be supplied to the CPU much quicker than the DRAM system memory can normally operate. Although very fast, SRAM has a much lower memory density than DRAM, so that a significant area on the motherboard is occupied by SRAM chips of just one to two hundred kilobytes. In comparison, DRAM chips occupying a similar sized area can easily hold more than thirty megabytes. SRAM is also significantly more expensive than DRAM.

A conventional motherboard is a very crowded piece of real estate that holds a discrete CPU, at least two control chips, system memory chips, cache memory chips, and I/O connectors. Long, tortuous paths interconnecting the large number of pins among the many devices create considerable routing congestion on the motherboard. The long paths cause signal propagation delays between the devices, capacitance, and electromagnetic radiation that causes radio frequency interference. As a result, the motherboard is difficult to design and expensive to produce. Furthermore, packaging such a congested board into the small case of a notebook computer is very difficult. This makes meeting the strong market demand for smaller and smaller notebook computers very challenging indeed. What is clearly needed is an integrated microprocessor wherein an I/O bus controller and a memory controller are implemented on the same IC as circuitry for more conventional microprocessor functions.

### SUMMARY OF THE INVENTION

In a preferred embodiment of the invention a single-chip IC device is provided comprising CPU means for performing digital arithmetical and logical processes, multiplexing I/O bus controller means for managing address and data communication to first external leads to an I/O bus, memory controller means for managing address and data communication to second external leads to a memory bus for communicating with one or more random access memory devices, and local bus means formed on the single-chip IC device for providing communication in parallel between the CPU means, the I/O bus controller means, and the memory controller means. The I/O bus controller means is configured to route memory requests from I/O devices through the memory controller means directly to the one or more random access memory devices.

A computer motherboard is provided with an I/O bus and a memory bus, and an integrated microprocessor as described above. A computer system is provided utilizing the single-chip integrated device on a motherboard.

The implementation of the computer elements as described on a single chip, and configured to provide a memory bridge, provides distinct advantages, especially for portable computers. The on-board local bus provides the quickest possible communication between the functional means of memory controller, CPU, and I/O bus control; much faster than with each implemented as a separate chip or chip set. Moreover, the on-board implementation provides a minimal power-using configuration, and provides an architecture therefore imminently suitable for small, portable systems. Additional advantages accrue in the form of reduced electromagnetic radiation in operation and in the minimal architectural complexity of a system based on an integrated device according to embodiments of the invention. Pin counts, PCB complexity are, for example, reduced.

### BRIEF DESCRIPTION OF THE DRAWINGS

FIG. 1 is a block diagram of a discrete CPU, memory controller, memory devices, and I/O bus controller according to the existing art.

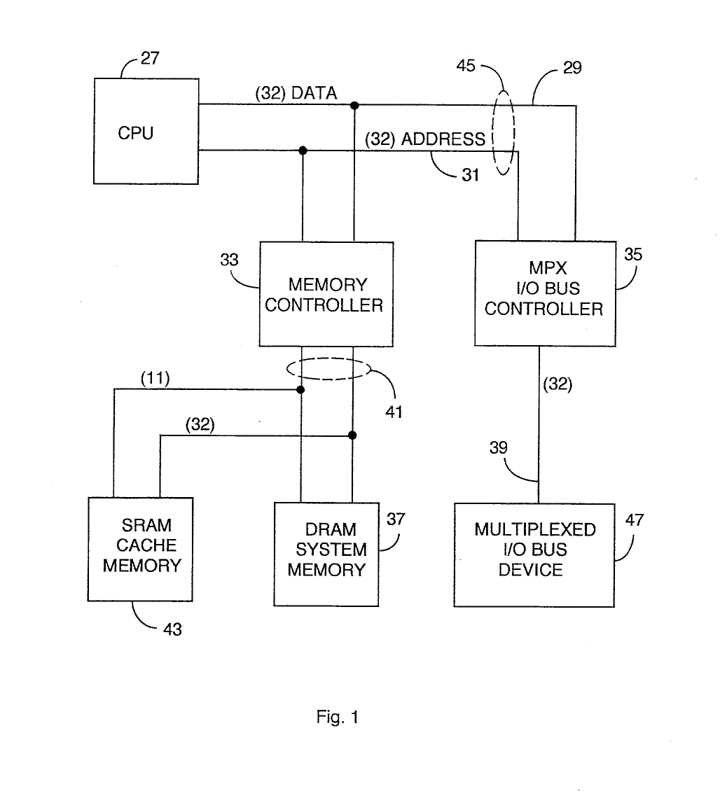

FIG. 2 is a schematic diagram of an integrated microprocessor according to an embodiment of the present invention.

### DESCRIPTION OF PREFERRED EMBODIMENTS

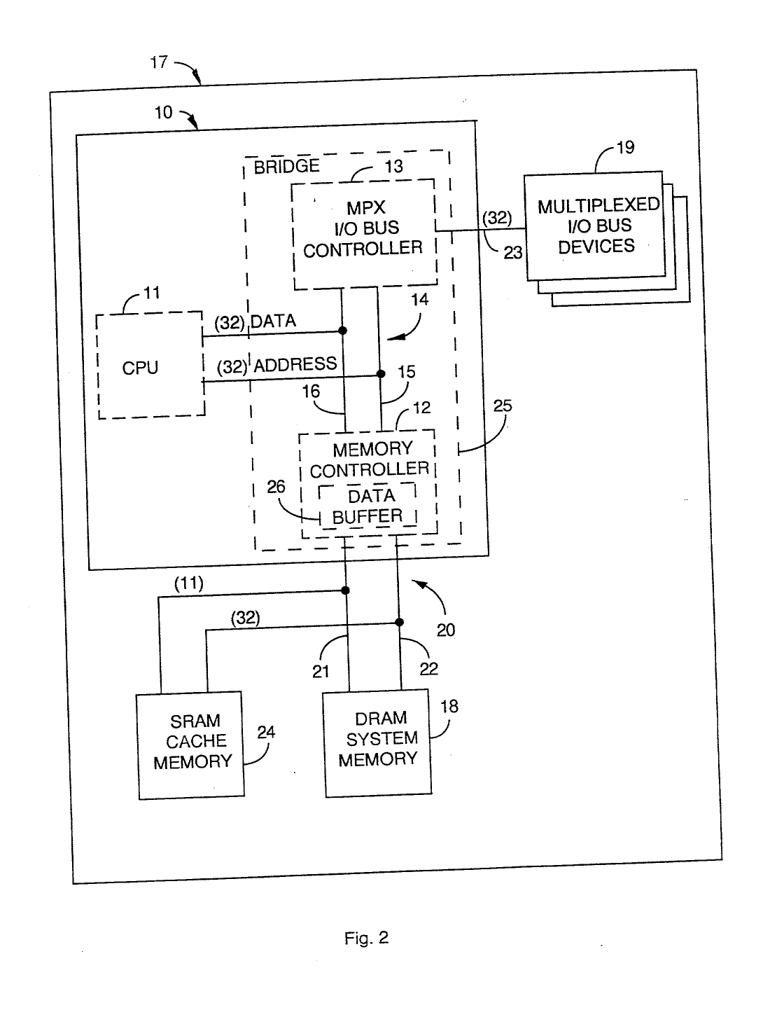

In a preferred embodiment of the invention as shown in FIG. 2, a microprocessor 10 comprises a CPU 11 compatible with the Intel 80×86 family of 32 bit processors, and a bridge 25. Bridge 25 comprises a memory controller 12 and a multiplexed I/O bus controller 13. The circuitry architecture for controllers to multiplex data and address words on common bus conductors is well known in the art, and not shown in detail. Memory controller 12 in this embodiment has a data buffer 26. Data buffer integrated circuitry is also known in the art and not described here in detail. CPU 11, memory controller 12, and multiplexed I/O bus controller 13 are all located on the same IC physical device, and are interconnected with a very short internal bus 14 comprised of address lines 15 and data lines 16. Bus structure 14 is implemented in the same manner as interconnects are typically provided in IC circuitry manufacture, that is, by metal deposition, lithographic patterning, and etching.

In this description, single-chip device 10 is termed an integrated microprocessor, because the functions generally performed by the circuitry thereon are functions typically performed by discrete microprocessors. Other terms of description might be preferable in some embodiments, and the terminology is not meant to be limiting.

DRAM system memory 18 and multiplexed I/O bus devices 19, such as a video co-processor, modem, or any other peripheral device, are directly connected to microprocessor 10 in this embodiment, rather than through a separate chip or chip set.

System memory 18 is connected to memory controller 12 within microprocessor 10 with a memory bus 20. Memory bus 20 comprises memory address lines 21 and memory data lines 22. Because DRAM is relatively slow, an optional cache memory 24 comprised of much faster SRAM can be added to boost performance. Cache memory 24 stores and makes available to CPU 11 the most frequently used information. Cache memory 24 also connects to memory controller 12 through memory bus 20. Multiplexed I/O bus device 19, exemplary of many I/O devices, is connected to multiplexed I/O bus controller 13 within microprocessor 10 through a multiplexed I/O bus 23. Necessary control lines on internal bus 14, memory bus 20, and multiplexed I/O bus 23 are not shown in the interest of clarity.

Because memory controller 12 is built into microprocessor 10, its functions can be tailored and optimized to support the memory addressing requirements and capabilities of CPU 11. The CPU can provide memory controller 12 advance information about its addressing needs, so that memory controller 12 can obtain the data ahead of time. When CPU 11 needs the information, memory controller 12 will be able to provide it immediately, without having to make CPU 11 wait for the controller to fetch it from system memory 18. Unlike conventional designs, CPU 11 does not have to go off-chip to access memory controller 12, so that its address and data cycle delays can be reduced by a factor of as much as ten or more from those of a conventional design. This saving may amount to as much as two clock cycles, and greatly enhances memory performance. It may also obviate need for expensive cache memory 24, so that board size and cost can be greatly reduced without a reduction in performance. Performance can also be enhanced by using burst mode data transfer, wherein several data words can be communicated following only one address cycle.

When multiplexed I/O bus device 19 issues a memory access request, bridge 25 routes it to system memory 18. Because bridge 25 is integrated into microprocessor 10, the interface overhead between multiplexed I/O bus controller 13 and memory controller 12 is significantly reduced, i.e., the address and data cycle delays are greatly shortened. As a result, system performance is further enhanced.

Microprocessor 10 in this embodiment has thirty-two (32) multiplexed address and data pins for connecting to I/O bus 23, and eleven (11) address pins and thirty-two (32) data pins for connecting to system memory 18 and optional cache memory 24. Therefore, consolidating CPU 11, memory controller 12, and I/O bus controller 13 into a single device has reduced the address and data pin count from a conventional two hundred sixty-seven (267), as described in the Background section, to only seventy-five (75). Because the package size of a chip is mostly dictated by its pin count, the package size of integrated microprocessor 10 is much smaller than the combined sizes of conventional, discrete chips.

Replacing several discrete chips with the single integrated microprocessor according to an embodiment of the present invention eliminates a large number of interconnection traces. Further, interface overhead is reduced, while performance is increased. Component size and population, as well as trace routing congestion, are significantly reduced on motherboard 17. The fewer traces can be made shorter, which reduces signal propagation delays, capacitance, and electromagnetic radiation. As a result, motherboard 17 is greatly simplified, so that it is much easier and less expensive to design. It can be made much more compact and less expensive to manufacture. This ultimately results in smaller and less expensive desktop and notebook computers.

The consolidation of normally separate motherboard components onto a single device can be applied to CPUs other than the Intel 80×86 family, such as the Intel Pentium, MIPS microprocessors, the Digital Equipment Corp. Alpha, the Motorola 680×0, etc. The pin counts in each case will vary according to the type of CPU, bus design, or memory device It will be apparent to one with skill in the art that there are many changes in detail that may be made in embodiments of the present invention without departing from the spirit and scope of the invention. The inventors are aware, for example, that given the descriptions above, workers with skill in the art may design a microprocessor according to an embodiment of the invention and implement it by conventional computer aided techniques and manufacturing methods. There are in this process many alternatives in design and construction, any and all of which may be employed without departing from the spirit and scope of the invention.

I claim:

1. A single-chip IC device comprising:
CPU means for performing digital arithmetical and logical processes;
multiplexing I/O bus controller means for managing address and data communication to first external leads to an I/O bus;
memory controller means for managing address and data communication to second external leads to a memory bus for communicating with one or more random access memory devices; and
local bus means formed on said single-chip IC device for providing communication in parallel between said CPU means, said I/O bus controller means, and said memory controller means;
said I/O bus controller means configured to route memory requests from I/O devices through said memory controller means directly to said one or more random access memory devices.

2. A single-chip device as in claim 1 wherein said memory controller means further comprises a data buffer.

3. A single-chip device as in claim 1 wherein said local bus means is configured to communicate 32-bit data and address words in parallel fashion.

4. A single-chip device as in claim 1 wherein said first external leads are configured to communicate either address or data in up to 32-bit length in parallel.

5. A single-chip device as in claim 1 wherein said second external leads are configured to communicate 32-bit data words and up to 12 address bits.

6. A computer motherboard comprising:
a multiplexed I/O bus having at least one connector for attaching an I/O bus peripheral;
memory bus means connected to system memory on said motherboard; and
a single-chip IC device mounted to said motherboard and connected to said memory bus means and to said multiplexed I/O bus, said single-chip I/O device comprising:
CPU means for performing digital arithmetical and logical processes;
multiplexing I/O bus controller means for managing address and data communication to first external leads connected to said multiplexed I/O bus;
memory controller means for managing address and data communication to second external leads connected to said memory bus means; and
local bus means formed on said single-chip IC device for providing communication in parallel between said CPU means, said I/O bus controller means, and said memory controller means;
said I/O bus controller means configured to route memory requests from I/O devices through said memory controller means directly to said system memory.

7. A computer motherboard as in claim 6 wherein said memory controller means further comprises a data buffer.

8. A computer motherboard as in claim 6 wherein said local bus means is configured to communicate 32-bit data and address words in parallel fashion.

9. A computer motherboard as in claim 6 wherein said first external leads are configured to communicate either address or data in up to 32-bit length in parallel.

10. A computer motherboard as in claim 1 wherein said second external leads are configured to communicate 32-bit data words and up to 12 address bits.

11. A computer motherboard as in claim 6 wherein said system memory comprises DRAM system memory and SRAM cache memory each communicating on said memory bus means.

12. A computer system comprising:
input means for receiving data and commands from a user;
display means for providing text and graphic output to the user; and
a computer motherboard comprising:
a multiplexed I/O bus having at least one connector for attaching an I/O bus peripheral;
memory bus means connected to system memory implemented as at least one IC package mounted to said motherboard; and
a single-chip IC device mounted to said motherboard and connected to said memory bus means and to said multiplexed I/O bus, said single-chip I/O device comprising:
CPU means for performing digital arithmetical and logical processes;
multiplexing I/O bus controller means for managing address and data communication to first external leads connected to said multiplexed I/O bus;
memory controller means for managing address and data communication to second external leads connected to said memory bus means; and
local bus means formed on said single-chip IC device for providing communication in parallel between said CPU means, said I/O bus controller means, and said memory controller means;
said I/O bus controller means configured to route memory requests from I/O devices through said memory controller means directly to said system memory.
